(19) United States
(12) Patent Application Publication
(10) Pub. No.: US 2025/0155901 A1
(43) Pub. Date: May 15, 2025

(54) DOSING METHOD AND SOLENOID VALVE FOR CARRYING OUT A DOSING METHOD

(71) Applicant: Festo SE & Co. KG, Esslingen (DE)

(72) Inventors: Andreas BÜHLER, Stuttgart (DE); Tobias WATZER, Deizisau (DE); Jens ENGELHARDT, Esslingen (DE)

(21) Appl. No.: 18/941,705

(22) Filed: Nov. 8, 2024

(30) Foreign Application Priority Data
Nov. 10, 2023 (DE) 10 2023 131 242.1

(51) Int. Cl. G05D 7/06; G01F 11/38

(52) U.S. Cl. CPC G05D 7/0635; G01F 11/38

(57) ABSTRACT

A dosing method for carrying out at least one dosing operation, including the steps: providing a switching signal to or from a valve control, providing a coil current from the valve control to a magnetic drive in dependence on the switching signal, in which the magnetic drive is configured to move a valve member of a solenoid valve between a normal position and a functional position, determining a first start of movement of the valve member from the normal position to the functional position, determining an operating duration between the provision of the coil current and the first start of movement, determining a providing duration for the switching signal. The provision of the coil current is carried out over a coil current duration which corresponds to a sum of the providing duration and the operating duration.

### CROSS-REFERENCE

This application claims priority to DE 10 2023 131 242.1, filed 10 Nov. 2023, which is incorporated herein by reference.

### BACKGROUND OF THE INVENTION

The invention relates to a dosing method and a solenoid valve for carrying out a dosing method.

Solenoid valves known from the state of the art for carrying out dosing methods have a valve member, a valve body, a sealing element associated with the valve member, a solenoid and a valve seat. The solenoid is configured for magnetic interaction with the valve member, which is also known as a plunger or a valve solenoid. When an electrical coil current is supplied to the solenoid, a magnetic force is exerted on the valve member to cause a relative movement with respect to the solenoid. With this relative movement, the seal element can either be lifted off the valve seat in order to bring the solenoid valve into a functional position, in particular into an open position, or pressed against the valve seat in a sealing manner in order to bring the solenoid valve into a normal position, in particular into a closed position.

The object of the present invention is to provide a dosing method and a solenoid valve for carrying out a dosing method which is inexpensive and quick to execute.

### SUMMARY OF THE INVENTION

The object is solved by a dosing method with the following features:

The dosing method for carrying out at least one dosing operation according to the invention comprises the steps: providing a switching signal to or from a valve control, providing a coil current from the valve control to a magnetic drive in dependence on the switching signal, wherein the magnetic drive is configured to move a valve member of a solenoid valve between a normal position and a functional position, determining a first start of movement of the valve member from the normal position to the functional position, determining an operating duration between the provision of the coil current and the first start of movement, determining a providing duration for the switching signal, wherein the provision of the coil current is carried out over a coil current duration which corresponds to a sum of the providing duration and the operating duration.

The valve control can be directly assigned to the magnetic drive or configured as a separate component, if necessary also for controlling several magnetic drives.

The switching signal can be provided by a circuit arrangement arranged in the valve control, in particular a microprocessor, or is provided to the valve control by a higher-level controller of the valve control, for example a machine controller of a dosing system. A higher-level controller is a controller that controls the valve control. This higher-level control can, for example, control several valve controls. The switching signal is used to cause the valve control to provide the coil current to the magnetic drive. For example, the valve control comprises a microprocessor and an electrical output stage arrangement connected to it, wherein the microprocessor activates the output stage arrangement when the switching signal is present in order to provide the coil current provided by a power source to the magnetic drive.

In addition to the valve member, the magnetic drive comprises a solenoid to which the coil current is supplied. The valve member is configured as part of a magnetic circuit, wherein a magnetic flux in this magnetic circuit depends on the properties of the solenoid, the coil current and the properties and positioning of the valve member. The valve member is moved between a normal position and a functional position depending on the energization of the solenoid. In the normal position, the valve member blocks a valve seat; in the functional position, the valve member releases the valve seat. In the normal position, the valve member can either rest directly against the valve seat, in which case the valve member preferably carries a rubber-elastic sealing element; the normal position is then referred to as the closed position and the functional position as the open position. Or the valve member can, for example, be separated from the valve seat by a flexible diaphragm so that the valve member presses the diaphragm onto the valve seat in the normal position.

When the coil current is supplied to the solenoid, the magnetic flux in the magnetic circuit changes. This results in a force being applied to the valve member with the aim of moving the valve member relative to the solenoid. Since a change in the magnetic flux is not time-synchronized with the provision of the switching signal and the coil current, for example due to the self-induction of the solenoid, and since the valve member may stick in the respective position, in particular the functional position or the normal position, if the magnetic drive is not actuated for a longer period of time, there is a time offset between the provision of the switching signal and the provision of the coil current to the solenoid and the actual movement of the valve member.

The operating duration is therefore the duration or period of time that lies between the provision of the coil current to the solenoid and the first start of movement of the valve member and represents a variable that depends on the operating conditions of the solenoid valve. Since the operating duration can vary depending on the operating conditions for the magnetic drive and the valve member, but an opening duration for the valve seat that is as exact as possible is to be realized for the implementation of the dosing method, the method according to the invention provides for the period of time between the provision of the switching signal and an actual movement of the valve member to be determined as the operating duration and to be taken into account in the actuation of the magnetic drive.

The providing duration determined during carrying out the method is the period of time between the initial provision of the switching signal to the valve control or from the valve control and the end of the provision of the switching signal and thus describes the period of time for which the switching signal is provided. In principle, the providing duration describes the period of time during which the solenoid valve is transferred from a normal position to a functional position by energizing the solenoid, wherein the normal position is typically the closed position and the functional position is typically the open position of the solenoid valve.

Since the solenoid valve is not immediately moved from the normal position to the functional position when the coil current is provided due to the operating conditions described above, but the actual time during which the solenoid valve is in the functional position is decisive for exact dosing, the valve control performs compensation, which is used in particular to compensate for the operating duration. For this purpose, the sum of the providing duration and the operating duration is provided as the duration for the provision of the coil current, wherein this period is referred to as the coil current duration.

The coil current duration therefore corresponds to the time for which coil voltage and thus coil current is applied or provided to the solenoid by means of the valve control.

The above-mentioned sticking of the seal element to the valve seat can occur to a greater extent when the solenoid valve is at a downtime for a longer period of time, i.e., the time during which the solenoid valve is in the normal position. In order to nevertheless ensure a desired opening time of the solenoid valve, so-called pre-shots can be carried out according to the state of the art, in which substrate exits through the solenoid valve in order to reduce sticking. This substrate cannot be reused, which leads to increased material costs, especially with expensive reagents. In addition, the duration of the pre-treatment delays the actual dosing application, which increases production times.

By determining the operating duration and extending the coil current duration by the operating duration, it can be ensured that the solenoid valve remains in the functional position at least until the desired amount of substrate has passed through the solenoid valve. In this way, pre-treatment with pre-shots can be avoided regardless of the downtime of the solenoid valve, which can reduce substrate loss and production times.

According to a preferred embodiment, after the end of the provision of the coil current, a second start of movement of the valve member from the functional position to the normal position, in particular from the open position to the closed position, is determined and a turn-off duration between the end of the provision of the coil current and the second start of movement of the dosing process is determined.

The movement of the valve member associated with the second start of movement is directed in the opposite direction to the movement associated with the first start of movement. The turn-off duration thus corresponds to the time required to set the valve member in motion from the functional position, in particular the open position, in the direction of the normal position, in particular the closed position. As with the movement of the valve member associated with the first start of movement, there is a delay due to the coil current in the movement of the valve member associated with the second start of movement. The delay due to the coil current results from the fact that the coil current does not cease abruptly at the end of the provision of the coil voltage, but decreases with a delay due to the solenoid coil. This delay is reflected in the turn-off duration.

The second start of movement occurs after the end of the provision of the coil current and is caused, for example, by a restoring force on the valve member, which leads to a restoring movement of the valve member from the functional position to the normal position after the magnetic flux in the magnetic circuit is reduced and the magnetic force effect on the valve member decreases as a result. For example, this restoring force can be provided by a spring, e.g., a compression spring.

Like the operating duration, the turn-off duration influences the dosing operation that is carried out with the solenoid valve, as the dosing operation is extended by the duration of the turn-off duration and therefore becomes less accurate. In order to reduce this inaccuracy during the dosing operation, it is preferred to shorten the coil current duration during a subsequent dosing operation by the turn-off duration determined during the previous dosing operation.

Preferably, the turn-off duration is averaged with at least one stored turn-off duration of a past dosing operation. For this purpose, a respective second start of movement of the valve member from the functional position to the normal position is determined during preferably several preceding dosing processes and a turn-off duration is determined in each case as the duration between the respective end of the provision of the coil current and the respective second start of movement. In this way, any inaccuracies occurring when determining the turn-off duration can be compensated for.

Preferably, in a subsequent dosing process, the provision of the coil current from the valve control to the magnetic drive is delayed by the turn-off duration from the point in time of the provision of the switching signal to or from the valve control, wherein the coil current duration is reduced by the turn-off duration. This ensures that the solenoid valve does not remain in the functional position longer than desired, which can increase the dosing accuracy. The delay in the provision of the coil current is carried out at the beginning of the dosing operation, i.e. from the point in time at which the switching signal is provided to or by the valve control, so that the providing duration of the dosing operation can be determined before the provision of the coil current is to be terminated again after the coil current duration, reduced by the turn-off duration, has elapsed. Since the coil current duration is determined as a function of the providing duration, it would otherwise not be possible to ensure that the coil current duration is actually reduced by the turn-off duration. In fact, if the turn-off duration is longer than the operating duration and therefore the coil current duration is less than the providing duration, the provision of the coil current would have to be terminated at a point in time at which the switching signal is still being provided and therefore the providing duration cannot yet be determined.

Preferably, the first start of movement and/or if applicable the second start of movement is determined on the basis of a profile of the coil current provided to the magnetic drive and/or on the basis of at least one sensor signal from at least one sensor, in particular a pressure sensor and/or flow sensor, assigned to the solenoid valve. The sensor or sensors can be positioned upstream and/or downstream of the valve seat in the substrate flow direction. If the first start of movement and/or, if applicable, the second start of movement is to be determined on the basis of a course of the coil current provided to the magnetic is drive, this is preferably done as follows.

When the valve member starts to move away from the valve seat, a current is induced in the opposite direction to the coil current, causing the coil current to drop briefly. This brief drop can be determined as the first start of movement. Similarly, when the coil current drops towards the end of the provision of the coil current, a counter-current-induced, brief increase in the coil current occurs when the valve member begins to move towards the valve seat. This can be detected as the second start of movement. If a pressure or flow sensor is used, the first and/or possibly the second start of movement can be determined by a change in pressure or flow rate. If the data from several sensors are used, they are preferably checked for plausibility, whereby the first and/or, if applicable, the second start of movement can be determined more accurately. This can increase the dosing accuracy.

According to a preferred embodiment, the switching signal is provided to the valve control by a controller that is higher-level than the valve control. This makes it possible for the higher-level control unit to control several control units, e.g., several valve controls. This means that corresponding circuit arrangements for providing the switching signal do not have to be provided in each valve control, but only one in the higher-level control. This can reduce manufacturing costs for the valve control.

Preferably, the providing duration is in each case compared with a plurality of individual providing durations of a plurality of individual preceding dosing operations, wherein the switching signal is provided to the valve control for the duration of an average value of the individual providing durations of the preceding dosing operations if there are in each case small differences between the providing duration and the individual providing durations of the preceding dosing operations. A small difference is defined in particular as a difference in an interval of 1 percent to 20 percent, preferably from 2 percent to 10 percent. In this way, time fluctuations in the control system providing the switching signal can be compensated for, which can increase the dosing accuracy. In addition, the minimum volumes that can be dosed by the solenoid valve can be reduced in this way. The time fluctuations occur due to the cycle time of the controller. The adjustment is preferably carried out by means of a further control unit that is subordinate to the control unit providing the switching signal and has a shorter cycle time than the control unit providing the switching signal.

The object is further solved by a solenoid valve with the following features:

A solenoid valve according to the invention comprises a valve control, a magnetic drive and a valve member, wherein the solenoid valve is configured to carry out a dosing method described above. The valve control is set up to perform the following steps: providing or receiving and processing the switching signal, and providing a coil current to the magnetic drive depending on the switching signal. Preferably, the valve control is also set up to perform the following steps: determining the first start of movement of the valve member from the normal position to the functional position, determining the operating duration between the provision of the coil current and the first start of movement and determining the providing duration for the switching signal.

According to a preferred embodiment, the valve control is positioned in a connecting cable positioned on the solenoid valve or in the solenoid valve. The connecting cable preferably connects the valve control, the magnetic drive and a higher-level control unit that provides the switching signal to the valve control. The connecting cable is then used to provide the switching signal from the higher-level controller to the valve control and the coil current from the valve control to the magnetic drive.

If the valve control is positioned in the connecting cable positioned on the solenoid valve, the functionality associated with the valve control can be displayed with existing solenoid valves. In addition, the same valve control can preferably be used for several solenoid valves, which can reduce costs. If the valve control is positioned in the solenoid valve, in particular the required installation space can be reduced.

Preferably, the valve control comprises a permanent voltage supply and/or a switching signal input. The permanent voltage supply can be used to supply the magnetic drive with electrical current as described above. By providing the switching signal input, it can be ensured that signals can be received by the valve control, in particular the switching signal.

### BRIEF DESCRIPTION OF THE DRAWINGS

The invention is explained in more detail below with reference to the enclosed drawing. It shows:

FIG. 1 a solenoid valve in a normal position,

FIG. 2 the solenoid valve displayed in FIG. 1 in a functional position,

FIG. 3 another solenoid valve with a valve control positioned in a connection cable,

FIG. 4 another solenoid valve with a valve control comprising a permanent voltage supply and a switching signal input,

FIG. 5 a diagram of a dosing process with a small operating duration,

FIG. 6 a diagram of another dosing process with a long operating duration,

FIG. 7 a diagram of another dosing operation with a coil voltage provided extended by the operating duration,

FIG. 8 a diagram of another dosing operation with a coil voltage extended by the operating duration and shortened by a turn-off duration,

FIG. 9 a dosing method,

FIG. 10 an alternative solenoid valve in a normal position, and

FIG. 11 the alternative solenoid valve shown in FIG. 10 in a functional position.

### DETAILED DESCRIPTION

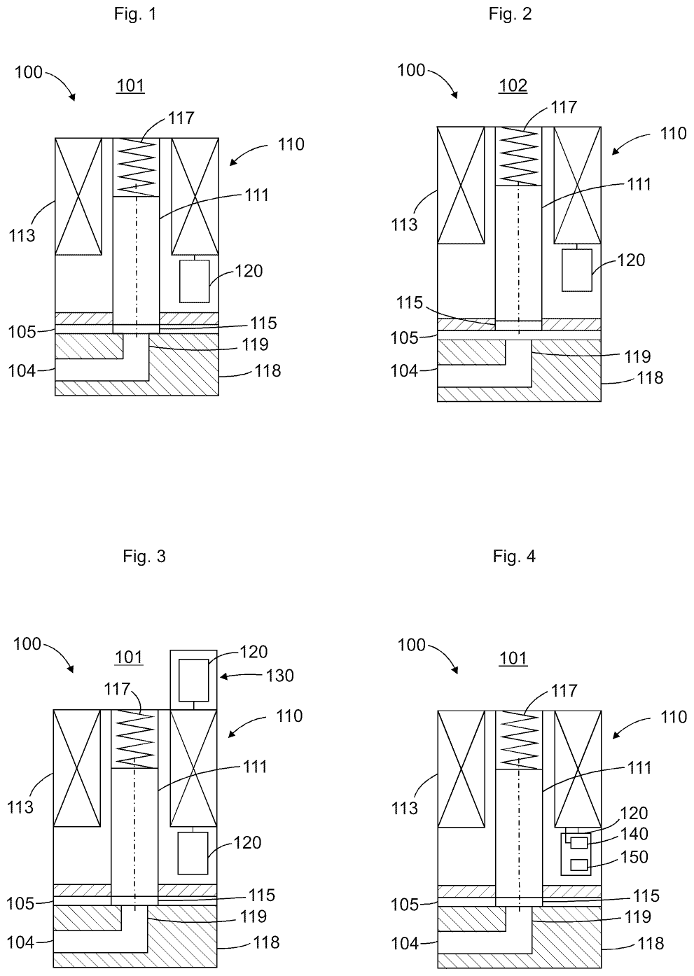

FIG. 1 shows a solenoid valve 100 in a normal position 101. The solenoid valve 100 has a magnetic drive 110, a seal element 115, a valve body 118, a valve seat 119, an inlet connection 104 and an outlet connection 105. The magnetic drive 110 preferably has a valve member 111 and a solenoid 113 surrounding the valve member 111. The valve member 111 is preferably configured as a valve solenoid. The solenoid 113 is shown in section. The seal element 115 is positioned on the valve member 111 and rests against the valve seat 119. This prevents fluid from passing between the seal element 115 and the valve seat 119 and being able to pass from the inlet connection 104 to the outlet connection 105, i.e., the solenoid valve 100 is in the normal position 101. Since the valve member 111 with the seal element 115 is in direct contact with the valve seat 119, the normal position is also referred to as the closed position.

Further, the solenoid valve 100 preferably comprises a compression spring 117, which presses the valve member 111 and thus the seal element 115 against the valve seat 119. This ensures that the solenoid valve 100 seals securely in the normal position 101. Furthermore, the solenoid valve 100 preferably comprises a valve control 120, which is connected to the magnetic drive 110, in particular to the solenoid 113. Preferably, the valve control 120 is set up to provide a coil current 343 to the magnetic drive 110. For this purpose, a coil voltage 345 is applied to the solenoid 113, causing the coil current 343 to flow in the solenoid 113. Simultaneously with the coil current 343 through the solenoid 113, a magnetic field results that acts on the valve member 111 in such a way that a magnetic force acts on it that counteracts the force caused by the compression spring 117. This causes the valve member 111 and thus the seal element 115 to be lifted off the valve seat 119, whereby the solenoid valve 100 is moved into a functional position 102 shown in FIG. 2, which is referred to here as the open position in accordance with the normal position 101 referred to as the closed position. In the functional position 102, the seal element 115 is spaced apart from the valve seat 119 in such a way that fluid can pass between the seal element 115 and the valve seat 119 and thereby pass from the inlet connection 104 to the outlet connection 105.

FIG. 3 shows a further solenoid valve 100, which differs from the solenoid valve 100 shown in FIGS. 1 and 2 in that it does not comprise a valve control 120. Preferably, a connecting cable 130 is connected to the solenoid valve 100 shown in FIG. 3, in which the valve control 120 is positioned. In the embodiment shown in FIG. 3, as in the embodiment shown in FIGS. 1 and 2, the valve control 120 is also connected to the magnetic drive 110. The solenoid valve 100 shown in FIG. 3 is in the normal position 101.

FIG. 4 shows a further solenoid valve 100 which differs from the solenoid valve 100 shown in FIGS. 1 and 2 in that the valve control 120 preferably has a permanent voltage supply 140 and a switching signal input 150. The permanent voltage supply 140 can be used to provide the coil voltage 345 from the valve control 120 to the solenoid 113, for which a corresponding connection is preferably provided. A switching signal 341 can be received from the valve control 120 via the switching signal input 150. Preferably, the switching signal 341 is processed by the valve control 120 in such a way that, depending on the switching signal 341, the coil voltage 345 provided by the permanent voltage supply 140 is applied to the solenoid 113 and thus the coil current 343 is provided to the magnetic drive 110. Alternatively, the valve control 120 can be set up to provide the switching signal 341 itself, so that the valve control 120 does not have to have a switching signal input 150. According to a further alternative, the permanent voltage supply 140 can be positioned outside the valve control 120.

Preferably, the valve control 120 is configured to perform the following steps: providing or receiving and processing the switching signal 341, providing the coil current 343 to the magnetic drive 110 as a function of the switching signal 341, determining the first start of movement of the valve member 111 from the normal position 101 to the functional position 102, determining an operating duration 303 between the provision of the coil current 343 and the first start of movement and determining a providing duration 301 for the switching signal 341.

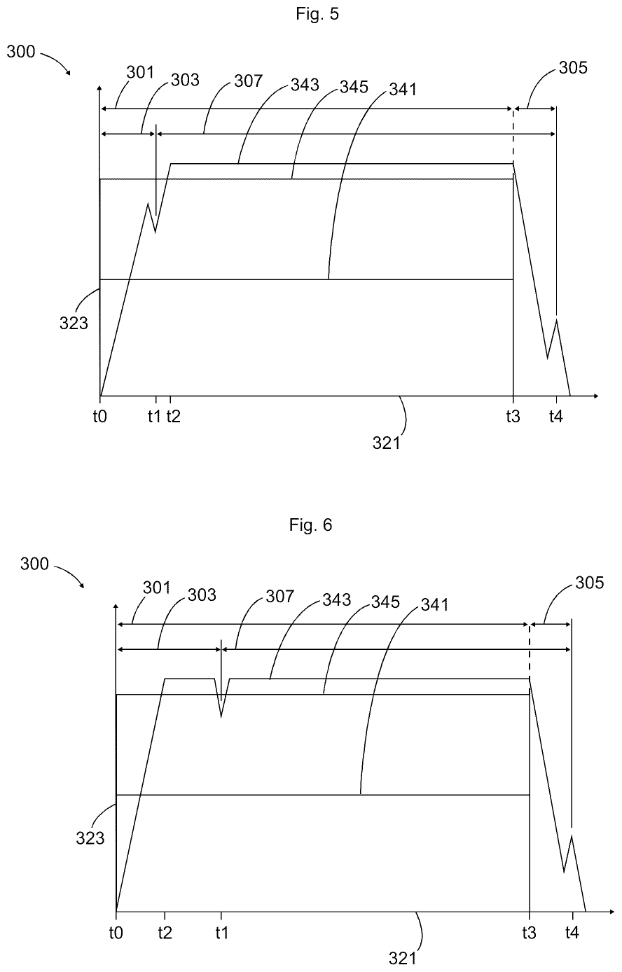

FIG. 5 shows a diagram 300 of a dosing process during which the steps described above are carried out by the valve control 120. In the diagram 300, the respective progression of the switching signal 341, the coil current 343 and the coil voltage 345 are plotted on a value axis 323 over a time axis 321. At a point in time t0, i.e., at the beginning, in other words at the left end of the time axis 321, the switching signal 341 and the coil voltage 345 are provided in full at the same time. From this point in time, the coil current 343 begins to rise. For the sake of simplicity, the increase is shown linearly in FIG. 5, but in reality, it can also take a different course, e.g., as an exponential function.

The rising line of the coil current 343 is interrupted at a point in time t1 by a brief drop. At the point in time t1, the valve member 111 begins to move away from the valve seat 119, inducing a current in the opposite direction to the coil current 343, which leads to the brief drop described above. The point in time t1 is preferably detected as the point in time of the first start of movement, so that the operating duration 303 can be determined between the provision of the coil current 343 at the point in time t0 and the first start of movement at the point in time t1. Alternatively, the point in time of the first start of movement can be determined using at least one sensor signal from at least one sensor associated with the solenoid valve 100, in particular a pressure sensor and/or flow sensor.

After the coil current 343 increases, it remains at a constant level from a point in time t2 until the coil voltage 345 drops at a point in time t3, whereupon the coil current 343 also drops. In the diagram 300 shown in FIG. 5, the drop in coil voltage 345 goes hand in hand with the drop in switching signal 341. The drop in coil current 343 and its rise are shown in simplified linear form. The falling straight line of the coil current 343 is interrupted by a brief rise at a point in time t4. At the point in time t4, the valve member 111 begins to move in the direction of the valve seat 119, inducing a current in the opposite direction to the coil current 343, which leads to the brief increase described above.

Preferably, this second start of movement is detected. The detection of the second start of movement is preferably performed in the same way as the detection of the first start of movement. Preferably, a turn-off duration 305 is determined between the end of the provision of the coil current 343, i.e., the point in time t3, and the second start of movement, i.e., the point in time t4. The duration between the point in time t1 and the point in time t4 is referred to as the dosing duration 307 and corresponds to the duration during which fluid can pass through the seal element 115 and the valve seat 119 and pass from the inlet connection 104 to the outlet connection 105.

FIG. 6 shows a diagram 300 of another dosing operation. The dosing operation shown in FIG. 6 differs from the dosing operation shown in FIG. 5 in that the first start of movement takes place at a later point in time. In FIG. 6, unlike in FIG. 5, the brief drop in coil current 343 does not take place during the rise in coil current 343, but only while it remains at a constant level. Accordingly, in the diagram shown in FIG. 6, the point in time t1 is after the point in time t2. As a result, the operating duration 303 of the dosing operation shown in FIG. 6 is longer than the operating duration 303 of the dosing operation shown in FIG. 5.

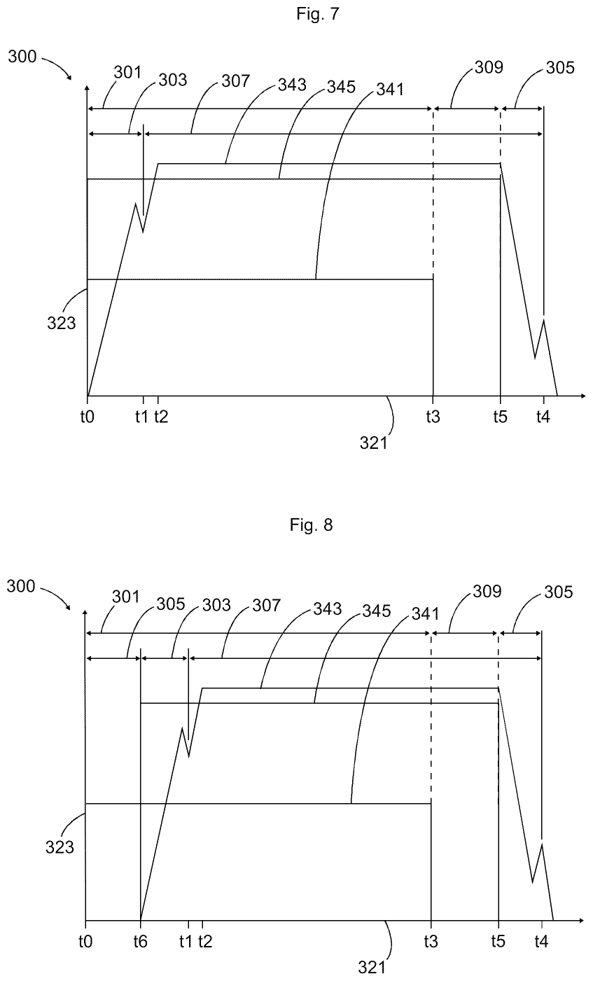

In order to ensure that the desired amount of substrate passes through the solenoid valve 100 despite operating durations 303 of different lengths, the coil current 343 is provided over the duration of a coil current duration according to the invention, which corresponds to a sum of the providing duration 301 and the operating duration 303. In FIG. 7, a correction duration 309 follows at the end of the providing duration 301, i.e., at the point in time t3 up to a point in time t5. In the dosing operation shown in FIG. 7, the correction duration 309 corresponds to the operating duration 303. The dosing duration 307 is therefore the sum of the providing duration 301 and the turn-off duration 305.

In the dosing operation shown in FIG. 7, the dosing duration 307 is longer than the providing duration 301, which means that potentially more substrate passes through the solenoid valve 100 than desired. This is negligible for larger dosing quantities or low turn-off durations 305. With smaller dosing quantities or long turn-off durations 305, however, this may mean that the dosing accuracy can no longer be kept within the required range.

In order to ensure that the dosing accuracy is nevertheless kept within the required range, the provision of the coil current 343 from the valve control 120 to the magnetic drive 110 is preferably delayed by the turn-off duration 305 from the point in time t0 up to a point in time t6, wherein the coil current duration now corresponds to a sum of the providing duration 301 and the operating duration 303 minus the turn-off duration 305. In the dosing process shown in FIG. 8, the correction duration 309, i.e., the duration between t3 and t5, corresponds to the operating duration 303 minus the turn-off duration 305. The dosing duration 307 therefore corresponds to the providing duration 301.

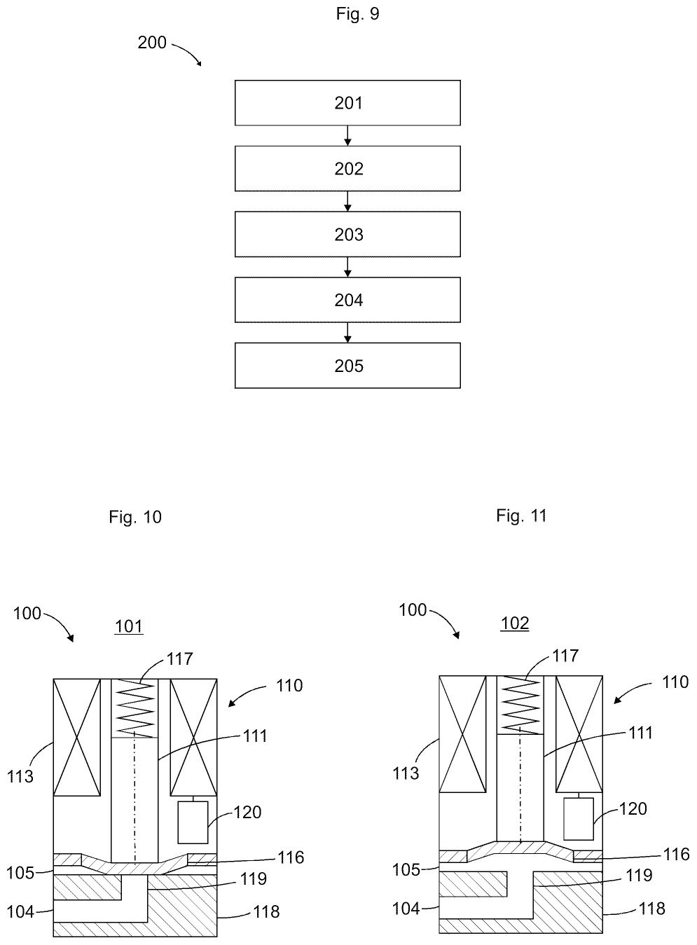

FIG. 9 shows a dosing method 200 for carrying out at least one dosing operation with the following steps. In a first step 201, the switching signal 341 is provided to or by a valve control 120. In a subsequent step 202, the coil current 343 is provided by the valve control 120 to the magnetic drive 110 as a function of the switching signal 341. This dependency can consist in the fact that the coil current 343 is also provided directly with the switching signal 341. This dependency can also consist in the fact that, after the switching signal 341 has been provided for the first time, the coil current 343 is provided with a delay, preferably with the delay by the turn-off duration 305. In a step 203 following step 202, the first start of movement of the valve member 111 from the normal position 101 to the functional position 102 is determined. In a subsequent step 204, the operating duration 303 between the provision of the coil current 343 and the first start of movement is determined. Finally, in a last step 205, the providing duration 301 for the switching signal 341 is determined, wherein the coil current 343 is provided over the duration of the coil current duration, which corresponds to a sum of the providing duration 301 and the operating duration 303.

FIG. 10 shows an alternative solenoid valve 100 in the normal position 101, FIG. 11 shows the alternative solenoid valve 100 in the functional position 102. The alternative solenoid valve 100 comprises essentially the same components as the solenoid valve 100 shown in FIGS. 1 to 4. However, the alternative solenoid valve 100 differs from the solenoid valve 100 shown in FIGS. 1 to 4 in that the alternative solenoid valve 100 does not comprise a sealing element 115 positioned on the valve member 111, but instead comprises a membrane 116 against which the valve member 111 merely rests. The membrane 116 is connected to the valve body 118 and is configured and positioned above the valve seat 119 in such a way that when the valve member 111 is at the bottom, i.e. when the solenoid valve 100 is in the normal position 101, the membrane 116 is pressed onto the valve seat 119 so that the solenoid valve 100 seals securely. If the valve member 111 is at the top, i.e. the solenoid valve 100 is in the functional position 102, the diaphragm 116 is spaced apart from the valve seat 119 in such a way that fluid can pass between the diaphragm 116 and the valve seat 119 and pass from the inlet connection 104 to the outlet connection 105.

1. A dosing method for carrying out at least one dosing operation, comprising the steps:
providing a switching signal to or from a valve control,
providing a coil current from the valve control to a magnetic drive in dependence on the switching signal, wherein the magnetic drive is configured to move a valve member of a solenoid valve between a normal position and a functional position,
determining a first start of movement of the valve member from the normal position to the functional position,
determining an operating duration between the provision of the coil current and the first start of movement,
determining a providing duration for the switching signal, wherein the provision of the coil current is carried out over a coil current duration which corresponds to a sum of the providing duration and the operating duration.

2. The dosing method according to claim 1, wherein after the end of the provision of the coil current, a second start of movement of the valve member from the functional position to the normal position is determined and a turn-off duration between the end of the provision of the coil current and the second start of movement of the dosing process is determined.

3. The dosing method according to claim 2, wherein the turn-off duration is averaged with at least one stored turn-off duration of a past dosing operation.

4. The dosing method according to claim 2, wherein, in a subsequent dosing process, the provision of the coil current from the valve control to the magnetic drive is delayed by the turn-off duration from the point in time of the provision of the switching signal to or from the valve control, wherein the coil current duration is reduced by the turn-off duration.

5. The dosing method according to claim 1, wherein the first start of movement is determined on the basis of a profile of the coil current provided to the magnetic drive.

6. The dosing method according to claim 1, wherein the switching signal is provided to the valve control by a controller that is higher-level than the valve control.

7. The dosing method according to claim 1, wherein the providing duration is in each case compared with a plurality of individual providing durations of a plurality of individual preceding dosing operations, wherein the switching signal is provided to the valve control for the duration of an average value of the individual providing durations of the preceding dosing operations if there are in each case small differences between the providing duration and the individual providing durations of the preceding dosing operations.

8. A solenoid valve comprising:
a valve control,
a magnetic drive, and
a valve member,
is wherein the solenoid valve is configured to carry out a dosing method for carrying out at least one dosing operation, comprising the steps:
providing a switching signal to or from a valve control,
providing a coil current from the valve control to a magnetic drive in dependence on the switching signal, wherein the magnetic drive is configured to move a valve member of a solenoid valve between a normal position and a functional position,
determining a first start of movement of the valve member from the normal position to the functional position,
determining an operating duration between the provision of the coil current and the first start of movement,
determining a providing duration for the switching signal, wherein the provision of the coil current is carried out over a coil current duration which corresponds to a sum of the providing duration and the operating duration.

9. The solenoid valve according to claim 8, wherein the valve control is positioned in a connecting cable positioned on the solenoid valve or in the solenoid valve.

10. The solenoid valve according to claim 8, wherein the valve control comprises a permanent voltage supply.

11. The dosing method according to claim 1, wherein the first start of movement is determined on the basis of at least one sensor signal from at least one sensor.

12. The dosing method according to claim 11, wherein the first start of movement is determined on the basis of at least one sensor signal from a pressure sensor assigned to the solenoid valve.

13. The dosing method according to claim 11, wherein the first start of movement is determined on the basis of at least one sensor signal from a flow sensor assigned to the solenoid valve.

14. The solenoid valve according to claim 8, wherein the valve control comprises a switching signal input.
